(19) United States
(12) Patent Application Publication
(10) Pub. No.: US 2006/0202177 A1
(43) Pub. Date: Sep. 14, 2006

(54) Flame retardant composition

(75) Inventor: Kang-Hung Chen, Chang Hua Hsien (TW)

Correspondence Address: William B. Patterson;Moser, Patterson & Sheridan, L.L.P., Suite 1500, 3040 Post Oak Boulevard, Houston, TX, 77056, US

(73) Assignee: TAIWAN TEXTILE RESEARCH INSTITUTE

(21) Appl. No.: 11/077,926

(22) Filed: Mar. 11, 2005

(51) Int. Cl. C09K 21/00

(52) U.S. Cl. 252/609; 524/445; 524/440

(57) ABSTRACT

A flame retarded composition for polyester or plastic is provided to enhance the fire resistant property of the polyester or the plastic. The composition at least includes a mixture of copper nanoparticles and clay. Copper ions are mixed with clay and the copper ions in the clay are reduced by reduce Cuent to form the copper nanoparticles. The clay containing copper nanoparticles are added and mixed in the polyester in the process for forming polyester chips and the chips with fire resistant property are formed. The chips, which have fire resistant property, is heated and used to produce fibers. The fibers are weaved to form the stuff, which has fire resistant property.

### BACKGROUND OF THE INVENTION

1. Field of the Invention

The present invention relates to a flame retard composition for fabric products or plastic. More specifically, the present invention relates to a flame retard composition for a polyester material or a multiplex polyester material.

2. Description of the Related Art

The fabric products or the plastic which is made of the artificial polymers have been wildly used in human beings' life. Most artificial polymers are organic compounds. Generally, one of the characteristics of the organic compounds is low ignition point and high inflammability. For this reason, developing and exploitation a fabric product or plastic with flame-retardant characteristic for protecting the safety of personnel and livelihood or for special utility is necessary. The development of the fabric product or plastic with flame-retardant characteristic is in progress.

Traditionally, a flame retardant reagent with halide or phosphorous is used as additive to manufacture the noncombustible artificial polymers, but using halide or phosphorous has many disadvantages, such as, expensive, large amount additivity, environment pollution, and contravening codes relating protection environment. Using the traditional flame retardant reagent is not only raising the cost but also altering the characteristic of the artificial polymer for the reason of large amount additivity. Moreover, using the halide or phosphorous as flame retardant reagent always increases the risk of damage to the people. Therefore, the traditional flame retardant reagent cannot match the specifications under the environmental code of many developed countries and the artificial polymer and products with the traditional flame retardant reagent cannot be imported or sold at the market of these countries. To solve the problems disclosed above, developing a new flame retardant reagent is necessary.

Clay is one of hottest nano materials in research field. Clay has many functions, such as, emitting far infrared, anti-fungous effect, anti-UV, durability, dimension stability and flame retardant.

For several characteristics of the clay, the clay can be used as a flame retardant reagent. The first, clay is a kind of inorganic material, silicate, and it is not flammable. The second, the stratiform structure of the clay can inhibit or decrease the oxygen penetrating in the plastic or resin when the clay is mixed in the plastic or resin. The third, a coal layer is formed and coats outside after the mixture of the clay and the plastic or the clay and the resin has been burned to protect the inside part avoiding damage by the flame. Basing on the three characteristics of the clay, clay is added into the polymer as a flame retardant reagent.

The use of clay for a flame retardant reagent is disclosed in several US patents. In U.S. Pat. No. 4,280,949, titled “MODIFIED POLYESTER COMPOSITIONS CONTAINING MINERAL FILLER” and published in Jul. 28, 1981, discloses a modified thermoplastic polyester compositions comprising a flame-retarding agent, a mineral filler, such as clay and polyesters. In U.S. Pat. No. 5,773,502, titled “FIRE RETARDANT BLENDS” and published in Jun. 30, 1998, discloses a substantially flame retardant composition comprising: (a) a thermoplastic polyester and co polyester material, a halogenated organic fire retardant, antimony oxide, organo clay, and a fluorocarbon polymer. The combination of the organo clay and the fluorocarbon polymer exhibits a synergistic effect on the fire retardant properties of the instantly claimed composition. This synergistic effect helps reduce the amount of the halogenated organic fire retardant in the instantly claimed flame retardant composition.

In the disclosures of prior arts, the clay always play as a comprimario because the flame retardant characteristic of clay is not enough to match the requirement, the main component of the flame retardant reagent is still halide or phosphorous. The problems caused by the halide or phosphorous flame retardant reagent is descended but could not be avoided because the clay just reduce the use of the amount of the halogenated organic fire retardant.

### SUMMARY OF THE INVENTION

Therefore, the present invention provides a modified clay composition and the composition has a high flame retardant effect.

One aspect of the present invention is to provide a flame retardant composition with high flame retardant effect, the composition comprises clay and copper nanoparticles.

Another aspect of the present invention is to provide a flame retardant composition with high flame retardant effect, the composition frees of traditional flame retardant reagent which contains halogenated organic fire retardant reagent or phosphorous fire retardant reagent.

The other aspect of the present invention is to provide a flame retardant composition with high flame retardant effect, the amount of the composition added into the polymer or plastic could be far less than the amount of the traditional flame retardant reagent, and the physical properties of the polymer and plastic are not changed.

The other aspect of the present invention is to provide a flame retardant composition with high flame retardant effect, the composition dose not cause environment pollution.

According to the aspects disclosed above, the present invention provides a flame retardant composition with high flame retardant effect for fibrous stuff or plastic. The present invention provides a mixture which is used to enhance the characteristic of retarding flame of polyester or polyester complex material. The mixture is made by copper nanoparticles and clay. The clay is selected from the group consisting of montmorillonite, bentonite, beidellite, nontronite, saponite, vermiculites, hectorite, volknerite, hydrotalcite, muscovite, biotite, attapulgite, talc, pyrophyllite, and mixtures thereof.

First of all, a cupric salt or a cuprous salt, such as, cupric nitrate, cupric nitrite, cupric chloride, copper sulfate, cuprous nitrate, cuprous nitrite, cuprous chloride, cuprous sulfate, and mixtures thereof, mixes with the clay in a special rati0. The mixture containing copper ions and clay is deposited in a deionized water, then the aqueous solution is blended in a temperature for a period of time. The temperature is about from room temperature to 95° C. and the preferred temperature is from 40° C. to 90° C. The period of time is about from 3 hours to 48 hours and the preferred time period is from 5 hours to 24 hours. After finishing the blending, the clay containing copper ions is gotten by removing the water and washing the residue with deionized water.

A reduction reagent, such as sodium boron hydride, sodium citrate, lithium aluminum hydride, lithium tri-(t-butoxy) aluminum hydride, hydrazine, metal hydride, alkaline metal or other similar reducing reagent, is used to reduce the copper ion to copper. The particle size of the copper is in nanometer scale because the copper ion is dispersed by the clay. The particle size of the copper is about from 5 nanometer to 500 nanometer. The clay containing copper nanoparticles could be used to mix with the polyester powder. After the mixture is dried, it can be prepared for advantage usage.

A modifier could be used to increase the hydrophobic characteristics of the clay for enhancing the interactions between the clay and the polyester. The modifier is an ammonium salt, especially a primary and a quaternary ammonium salt with straight chain alkyl group, such as a primary ammonium salt or an amino acid containing a straight chain alkyl with 3 carbons to 17 carbons, cetyltrimethylammonium bromide (CTAB), cetyltrimethylammonium chloride (CT AC), distearyldimethylammonium chloride, stearylbenzyldimethylammonium chloride, n-alkyltriethylammonium bromides or chloride, n-alkyltriethylammonium bromides or chloride and so on, wherein the carbon number of the n-alkyl is 13, 15, 17, 21, or 23. The clay containing copper nanoparticles could be used to mix with the polyester powder. After the mixture is dried, it can be prepared for advantage usage.

The polyester mentioned above is polyethylene terephthalate (PET), polybutylene terephthalate (PST), the mixture of PST and PET or other polyester. A single screw extruder or twin screw extruder could be used for producing chips, which contains polyester and clay with copper nanoparticles.

It has been well-known that the copper nanoparticles can be used as a anti-fungus reagent, but in the present invention the copper nanoparticles are not only used as an anti-fungus reagent but used as flame retardant reagent. The block copper is a kind of stable and inactive metal, therefore the copper, likes the mercury, platinum and gold, belongs to noble metal. When the particle of the copper sizes down to nano-scale, the characteristics, such as catalysis, is different from the block size. The copper nanoparticles disclosed in the present invention is used as a catalyst. The carbon monoxide made from a burning plastics is catalyzed by the copper nanoparticle to become carbon dioxide. The carbon dioxide surrounds the burning plastic to stop the plastics continuously burning. At the same time, a parching layer, which is made from the clay and copper nanoparticles, coating cover the plastics is to protect the inner parts of the plastics from the flame.

Generally speaking, the clay contains some metal ion, such as sodium. The copper ion will substitute the metal ion inside the clay by an ion exchange reaction when the clay and the copper ion stir together in the aqueous solution. The argentous amount in the clay depends on the cation exchange capacity of the clay, normally is not more than 15% w.t. The argentous amount in the clay is between about 0.03% w.t and 10% w.t., preferred is between about 0.5% w.t and 8% w.t.

The amount of the Cu/clay added in the polyester depends on the demand. More Cu/clay is added and better flame retardant effect achieves. In fact, only 0.01% w.t Cu/clay additional amount in the polyester is enough to get flame retardant effect and 0.25% w.t Cu/clay additional amount in the polyester is enough to match the demand, for example, the limited oxygen index (LOI) for the commercial product. Ordinarily, 0.01% w.t to 20% w.t Cu/clay additional amount for the polyester or the plastic is enough, but for some rigorous requirement, such as some high flame retardant material, the additional amount of the Cu/clay will reach 30% w.t. The flame retardant effect, illuminated in the experimental results, is very good even though the Cu/clay additional amount is less than 1% w.t, and the preferred results are illuminated while the Cu/clay additional amount is between about 0.2% w.t and 2% w.t. As the disclosure above, the ratio of the copper nanoparticle/polyester is between about 10 ppm and 1% w.t and the ratio of clay/polyester is between about 0.01% w.t and 2% w.t.

Because the modified clay composition contains copper nanoparticles is provided in the present invention has a high flame retardant effect, therefore, the composition frees of traditional flame retardant reagent and the problems caused by the traditional flame retardant reagent, such as the environment pollution, high cost and altering the characteristic of the artificial polymer, are solved. The modified clay composition contains free of halogenated organic fire retardant reagent or phosphorous fire retardant reagent, the environment will not be damaged by organo-halide or organo-phosphorous. The modified clay composition contains has a high flame retardant effect, the amount of the composition added into the polymer or plastic could be far less than the amount of the traditional flame retardant reagent, the physical properties of the polymer and plastic are not changed and the cost is also lower.

Additionally, although free of traditional retardant reagent is disclosed in the present invention, it doesn't mean that the Cu/clay flame retardant reagent disclosed in the present invention can not cooperate with the traditional retardant reagent. The Cu/clay flame retardant reagent also can cooperate the traditional retardant reagent to lower the amount of usage in the polyester or plastic.

### BRIEF DESCRIPTION OF THE DRAWINGS

These and other features, aspects, and advantages of the present invention will be more fully understood by reading the following detailed description of the preferred embodiment, with reference made to the accompanying drawings as follows:

FIG. 1 illuminates the result of filter test of the polybutylene terephthalate with 0.5% w.t clay; and

FIG. 2 illuminates the result of filter test of the polybutylene terephthalate with 0.5% w.t Cu/clay obtained from present invention.

### DETAILED DESCRIPTION OF THE PREFERRED EMBODIMENT

It is to be understood that both the foregoing general description and the following detailed description are exemplary, and are intended to provide further explanation for the modified clay composition and the method for manufacturing the same in the present invention. The first and the second example disclose a method for manufacturing the modified clay composition. The third example discloses using the modified clay composition to manufacture polyester chips. The fourth example discloses using the polyester chips produced in example 3 to manufacture fibers and testing the flame retardant characteristic of the fibers. The fifth example discloses the result of using the textile produced in example 4 to perform the anti-fungous effect test.

### Example 1

1.98 g (0.01 mole) of cupric nitrate and 1 g of clay (PK805) obtained from Pai Kong Ceramic Materials C0., Ltd. are deposited in 500 ml deionized water, then heat the water to 90° C. and stir it for 24 hours. The solution is stilled for a while then remove portion of the water. The participate is then isolated by centrifugation and is washed by deionized water. The participate is the Cu²⁺/clay mixture.

The Cu²⁺/clay mixture is then deposited in 100 ml deionized water. 0.1 g of sodium boron hydride is added into the water slowly and with magnetic stir. The sodium boron hydride is used as reducing reagent. Furthermore 0.05 g of sodium boron hydride is added in if necessary. The participate is then isolated by centrifugation and is washed by deionized water. The participate is the modified clay composition.

### Example 2

1.98 g (0.01 mole) of copper nitrate and 1 g of clay (PK805) obtained from Pai Kong Ceramic Materials C0., Ltd. are deposited in 500 ml deionized water, then heat the water to 90° C. and stir it for 24 hours. The solution is stilled for a while then remove portion of the water. The participate is then isolated by centrifugation and is washed by deionized water. The participate is the Cu²⁺/clay mixture.

The Cu²⁺/clay mixture is then deposited in 100 ml deionized water. 0.1 g of sodium boron hydride is added into the water slowly and with magnetic stir. The sodium boron hydride is used as reducing reagent. Furthermore 0.05 g of sodium boron hydride is added in if necessary. The participate is then isolated by centrifugation and is washed by deionized water. The participate is the Cu/clay.

The Cu/clay is deposited in 100 ml 0.01 M cetyltrimethylammonium Bromide (CTAB) solution, heating to 60° C. and stirring for 3 hours. The participate is then isolated by centrifugation and is washed by deionized water. The participate is the modified clay composition.

### Example 3

The modified clay composition (Cu/clay) achieved from Example 2 is dried and uniformly mixes with 3 kg of polybutylene terephthalate (PBT) powder. The mixture is put in a single screw extruder or a twin screw extruder for melt compounding chips, which contain polyester and clay with copper nanoparticles.

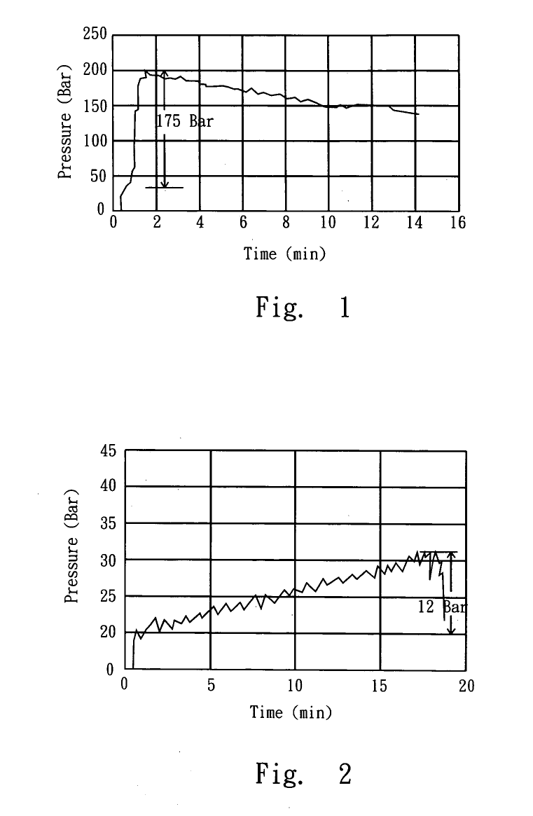

Before spinning in textile, filter test is an important study to avoid causing high pack pressure that will stop the spinning. In addition, the filter test also help to monitor enhance of affinity in the polyester/clay interface and detect the clay layer which is well-delaminated and dispersed in polyester matrix or not. If the pressure of the filter test is high, reticulation of the spinning will be jammed by the particles of the molten chips. The pressure of filter test of the chips containing clay only is very high. FIG. 1. illuminates the result of filter test of the polybutylene terephthalate with 0.5% w.t clay. The pressure illuminated in FIG. 1 achieves 175 Bar during the filter test. FIG. 2. illuminates the result of filter test of the polybutylene terephthalate with 0.5% w.t Cu/clay obtained from present invention. The pressure illuminated in FIG. 2 just 12 Bar during the filter test. As the result illuminated in FIG. 2, the Cu/clay disperses in the PBT very well without aggregation situation and the chips are suitable for industrial use. By the way, the chips with 0.25% w.t. Cu/clay are also produced to manufacture textile for flame retardant test disclosed in the Example 4.

### Example 4

The PBT chips containing 0.25% w.t Cu/clay is molten at the temperature between about 250° C. and 290° C. to make fiber. The fiber is spun to form flame retardant textile. Following the same procedures, the PBT chips and the PBT chips containing 0.25% w.t clay are also used to produce textile.

Following ASTM D 2863-95 standard testing procedures, the three textiles are used to perform a flame retardant test. The test results are listed in the table 1.

TABLE 1
The LOI of the three polyester textiles

| | | | 0.25 wt % Cu/Clay |
|---|---|---|---|
| Sample | PBT without clay | 0.25 wt % in PBT | in PBT |
| LOI value | 22 | 25 | >32 |

The LOI value of the textile made from the PST is only 22, and the LOI value of the textile made from the PST with 0.25% w.t clay is just little higher, 25, but the LOI value of the textile made from the PST with 0.25% w.t Cu/clay is very high, more than 32. The result illuminated that the Cu/clay composition is a very good flame retardant reagent and the copper nanoparticles has a very important contribution.

The LOI value of the textile made from the PST with 0.25% w.t Ag/clay is about 31. Comparing with test results are listed in the table 1, in the preliminarily observing, the values of LOI of the PST with 0.25% w.t Ag/clay and the PST with 0.25% w.t Cu/clay seems no difference, but after the molar number of the metal contained in the clay is induced to estimate the effect of flame retardant, the molar number of copper is just half of the molar number of silver. Therefore, the copper show higher flame retardant efficiency than the silver.

Generally speaking, in commercial demand, the LOI value of a textile is 28. The flame retardant reagent disclosed in the present invention provides a better result than the commercial demand. From the Examples disclosed above, there are several advantages to use the Cu/clay composition as a flame retardant reagent. Firstly, the present invention provides a modified clay composition and the composition has a high flame retardant effect. Secondarily, the composition frees of traditional flame retardant reagent which contains halogenated organic fire retardant reagent or phosphorous fire retardant reagent and the composition dose not cause environment pollution. Thirdly, the amount of the composition added into the polymer or plastic could be far less than the amount of the traditional flame retardant reagent, and the physical properties of the polymer and plastic are not changed and the cost is low.

### Example 5

The textile produced in example 4 is used to perform an anti-fungous effect test according the JIS Z 2911-2000 anti-fungous effect test standard method. The clones used in the test include ATCC 6275 (Aspergillus niger), ATCC 6205 (Chaetomium globosum), TCC 9095 (Myrocethium verrucaria) and ATCC 9849 (Penicillium citrinum). The growth of the clone is depressed.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

1. A flame retardant composition for polyester or plastic, the composition at least comprising:
copper nanoparticles, a size of the copper nanoparticles is from about 5 nanometer to about 500 nanometer; and
a clay, wherein the copper nanoparticles and the clay are mixed uniformly

2. The composition of claim 1, wherein the clay is a stratiform silicate.

3. The composition of claim 1, wherein the clay is selected from the group consisting of montmorillonite, bentonite, beidellite, nontronite, saponite, vermiculites, hectorite, volknerite, hydrotalcite, muscovite, biotite, attapulgite, talc, pyrophyllite, and mixtures thereof.

4. The composition of claim 1, wherein the ratio of the copper nanoparticles and the clay is from about 0.03% to about 10% by weight

5. The composition of claim 1, wherein the ratio of the copper nanoparticles and the clay is from about 0.5% to about 8% by weight.

6. The composition of claim 1, wherein the polyester is selected from polyethylene terephthalate, polybutylene terephthalate, and mixtures thereof.

7. The composition of claim 1, wherein the polyester or the plastic comprise more than 0.01% by weight of the flame retardant composition.

8. The composition of claim 1, wherein the polyester or the plastic comprise form more than 0.01% to about 30% by weight of the flame retardant composition.

9. The composition of claim 1, wherein the polyester or the plastic comprise form 0.2% to about 2% by weight of the flame retardant composition.

10. The composition of claim 1, further comprising a modifier.

11. The composition of claim 10, wherein the modifier is an ammonium salt.

12. The composition of claim 10, wherein the modifier is a primary or tertiary ammonium salt with straight alkyl chain.

13. The composition of claim 10, wherein the modifier is selected from the group consisting of amino acid, primary ammonium salt with C3 to C17 straight alkyl chain, cetyltrimethylammonium bromide, cetyltrimethylammonium chloride, distearyldimethylammonium chloride, stearylbenzyldimethyl-ammonium chloride, n-alkyltriethylammonium bromides, n-alkyltriethylammonium chloride, n-alkyltriethylammonium bromides, n-alkyltriethylammonium chloride, and mixtures thereof.

14. The composition of claim 13, wherein the carbon number of the n-alkyl group is 13, 15, 17, 21 or 23.

15. A flame retardant polyester chip, the chip at least comprising: a polyester or a plastic;
copper nanoparticles, a size of the copper nanoparticles is from about 5 nanometer to about 500 nanometer; and
a clay, wherein the polyester, the copper nanoparticles and the clay are mixed uniformly.

16. The chip of claim 15, wherein the clay is a stratiform silicate.

17. The chip of claim 15, wherein the clay is selected from the group consisting of montmorillonite, bentonite, beidellite, nontronite, saponite, vermiculites, hectorite, volknerite, hydrotalcite, muscovite, biotite, attapulgite, talc, pyrophyllite, and mixtures thereof.

18. The chip of claim 15, wherein the ratio of the copper nanoparticles and the clay is from about 0.03% to about 10% by weight.

19. The chip of claim 15, wherein the ratio of the copper nanoparticles and the clay is from about 0.5% to about 8% by weight.

20. The chip of claim 15, wherein the polyester is selected from Polyethylene Terephthalate, Polybutylene Terephthalate, and mixtures thereof.

21. The chip of claim 15, wherein the polyester or the plastic comprise more than 0.01% by weight of the flame retardant chip.

22. The chip of claim 15, wherein the polyester or the plastic comprise form more than 0.01% to about 30% by weight of the flame retardant chip.

23. The chip of claim 15, wherein the polyester or the plastic comprise form 0.2% to about 2% by weight of the flame retardant chip.

24. The chip of claim 15, further comprising a modifier.

25. The chip of claim 24, wherein the modifier is an ammonium salt.

26. The chip of claim 24, wherein the modifier is a primary or tertiary ammonium salt with straight alkyl chain.

27. The chip of claim 24, wherein the modifier is selected from the group consisting of amino acid, primary ammonium salt with C3-C17 straight alkyl chain, cetyltrimethylammonium bromide, cetyltrimethylammonium chloride, distearyldimethylammonium chloride, stearylbenzyldimethyl-ammonium chloride, n-alkyltriethylammonium bromides, n-alkyltriethylammonium chloride, n-alkyltriethylammonium bromides, n-alkyltriethylammonium chloride, and mixtures thereof.

28. The chip of claim 27, wherein the carbon number of the n-alkyl group is 13, 15, 17, 21 or 23.

29. A flame retardant polyester fiber, the fiber at least comprising:
a polyester;
copper nanoparticles, a size of the copper nanoparticles is from about 5 nanometer to about 500 nanometer; and
a clay, wherein the polyester, the copper nanoparticles and the clay are mixed uniformly.

30. The fiber of claim 29, wherein the clay is selected from the group consisting of montmorillonite, bentonite, beidellite, nontronite, saponite, vermiculites, hectorite, volknerite, hydrotalcite, muscovite, biotite, attapulgite, talc, pyrophyllite, and mixtures thereof.

31. The fiber of claim 29, wherein the ratio of the copper nanoparticles and the clay is from about 0.03% to about 10% by weight.

32. The fiber of claim 29, wherein the ratio of the copper nanoparticles and the clay is from about 0.5% to about 8% by weight.

33. The fiber of claim 29, wherein the polyester is selected from Polyethylene Terephthalate, Polybutylene Terephthalate, and mixtures thereof.

34. The fiber of claim 29, further comprising a modifier.

35. The fiber of claim 34, wherein the modifier is an ammonium salt.

36. The fiber of claim 34, wherein the modifier is a primary or tertiary ammonium salt with straight alkyl chain.

37. The fiber of claim 34, wherein the modifier is selected from the group consisting of amino acid, primary ammonium salt with C3-C17 straight alkyl chain, cetyltrimethylammonium bromide, cetyltrimethylammonium chloride, distearyldimethylammonium chloride, stearylbenzyldimethyl-ammonium chloride, n-alkyltriethylammonium bromides, n-alkyltriethylammonium chloride, n-alkyltriethylammonium bromides, n-alkyltriethylammonium chloride, and mixtures thereof.

38. The fiber of claim 34, wherein the carbon number of the n-alkyl group is 13, 15, 17, 21 or 23.

39. A method for fabricating a flame retardant reagent, comprising:
blending copper salt, a clay and deionized water at a temperature from room temperature to 95° C. for 3 hours to 48 hours;
removing the water; and
reducing copper ions of the copper salt to copper.

40. The method of claim 39, wherein the preferred temperature is from 40° C. to 90° C.

41. The method of claim 39, wherein the preferred time period for blending is from 5 hours to 25 hours.

42. The method of claim 39, wherein the copper salt is selected from a group consisting of copper nitrate, sliver nitrite, copper acetate, copper sulfate, and mixtures thereof.
